(19) United States
(12) Patent Application Publication
(10) Pub. No.: US 2020/0107540 A1
(43) Pub. Date: Apr. 9, 2020

(54) Deer Call

(71) Applicant: John Anthony Price, Terry, MS (US)

(72) Inventor: John Anthony Price, Terry, MS (US)

(21) Appl. No.: 16/592,636

(22) Filed: Oct. 3, 2019

Related U.S. Application Data
(60) Provisional application No. 62/741,075, filed on Oct. 4, 2018.

(51) Int. Cl. A01M 31/00; G10K 5/00

(52) U.S. Cl. CPC A01M 31/004; G10K 5/00

(57) ABSTRACT

A deer call apparatus that has a cylindrical sound chamber end and a mouthpiece end that is in communication with the sound chamber. A reed is positioned inside the sound chamber and vibrates when air is blown into the mouthpiece. The reed is positioned over a grove that is cut or molded into a sound board that allows air to flow under the reed and cause the vibrations that create the sound. The mouth piece end of the sound chamber has small aperture or restricted sized hole that will only allow a certain amount of air into the call to keep the reed from locking up or creating an unwanted sound from the reed and sound board. The exit end of the call has an aperture the same size as the mouthpiece end to control the sound emitted from the call.

### STATEMENT OF FEDERALLY SPONSORED RESEARCH OR DEVELOPMENT

Not applicable.

### BACKGROUND OF THE INVENTION

This invention relates to games calls for attracting whitetail deer and more particularly to a deer call that will produce the sounds of a female whitetail deer.

Many devices have been designed and built over the years to call game animals for hunters and photographers. Many of these have been developed to make the calls easier to use and produce the quality sounds of game. Many of these calls require years of practice to become proficient at producing the sounds needed to call in game.

Many of these calls that were designed for deer hunting were designed to make a grunt sound of a whitetail buck which is a deep low pitch tone. Some of these calls are adjustable to create many of the sounds of male deer and are susceptible to improper adjustments and are more likely to alarm the deer instead of attract them.

Nature designed male animals to be attracted to female animals during certain times and it only makes sense that to call in a male whitetail deer that one would want to make the sound of a female whitetail deer or doe. Prior efforts by other calls to produce this sound of the female whitetail have not been able to make it consistently without extensive skill by the caller. The present invention only makes the sound of a female whitetail deer and is easily repeatable time and time again without having extensive calling abilities. This will be of great value to whitetail hunters and wildlife photographers.

### BRIEF SUMMARY OF THE INVENTION

The invention presented here provides a deer calling device that will mimic specifically the bleat sound of a whitetail doe without any manipulation by the user. A further objective of the invention is to allow a novice caller or user to produce a desired tone of a female deer without extensive practice.

This invention comprises a game calling device having a body that is generally cylindrical in shape that has a bore through and specifically a call that consist of a mouth piece end and an exit end with a sound chamber in the middle and is in communication with each and that has a reed attached to a sound board that will vibrate when air is blown into the call and under said reed and through the tone channel and produces the bleat sound of a female whitetail deer. The mouth piece end has a small entrance hole or aperture that will only allow a certain small amount of air into the call and under the reed to keep the reed from locking or producing an unwanted sound. The exit end of the tubular call has an aperture the same size as the mouth piece end to further control the amount of air going through the call and the reed to create the consistent sound repeatedly.

### DESCRIPTION OF DRAWINGS

FIG. 1 is a cross-sectional view of the assembled form of the present invention;

FIG. 2 is an exploded perspective view of the present invention;

FIG. 3 is a cross-sectional view of an alternate embodiment form of the present invention;

FIG. 4 is a cross-sectional view of another alternate embodiment form of the present invention;

FIG. 5 is a cross-sectional view of another alternate embodiment form of the present invention;

FIG. 6 is a cross-sectional view of another alternate embodiment form of the present invention.

### DETAILED DESCRIPTION OF THE INVENTION

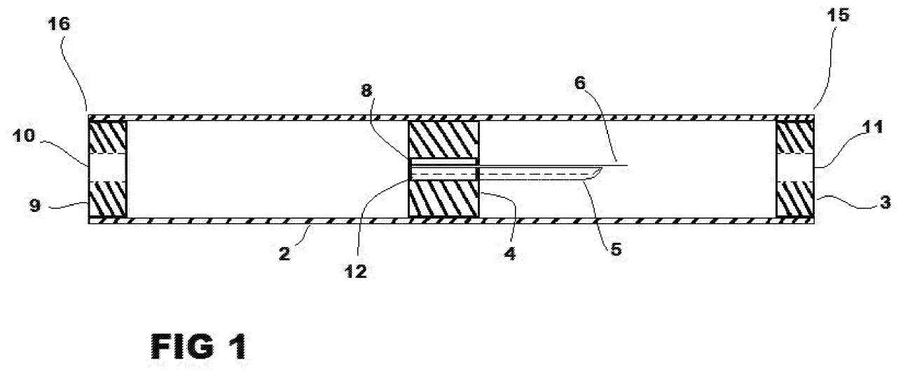

Referring to the drawings, FIG. 1, is one embodiment of a game call according to the present invention. The device has a main body portion 2, which in this drawing is one piece, one end of which is formed into a mouth piece end 15 and the other end is the barrel or exit end 16. The mouth piece end 15 consist of an insert or bushing 3 that contains an aperture 11 that is substantially smaller than the inside diameter of the main body 2. As air is blown into this mouth piece end 15 the small aperture 11 controls the amount of air that gets to the voice that consist of a reed 6 that is over the tone board 5 that has a grove or tone channel 12 cut into it and that is held in place by a wedge 8. This bushing may be made of any suitable material as to reduce the amount of air that can enter the call. The voice is held near the center of the main body 2 with a bushing 4 that contains an aperture that is the correct diameter to hold the voice. This bushing 4 may be inserted into the main body 2 or molded into the main body 2 of the device. The reed may be formed of any suitable material, such as plastic or resin-type material. The main body portion may also be formed from any suitable material such as wood or plastic. As the air passes through the tone channel 12 the reed 6 vibrates and creates the desired sound of a whitetail doe bleat. The air blown through the call goes through the exit end of the call 16 that consist of a bushing 9 with an aperture 10 the same diameter as the aperture in the bushing 3 on the mouthpiece end 15. The exit end aperture 10 of the device although shown near the center may be off center or a plurality of smaller apertures in the cap or bushing that would be equal to the diameter of the mouth piece bushing aperture to further control the amount of air escaping the call to maintain the proper sounds for a doe bleat.

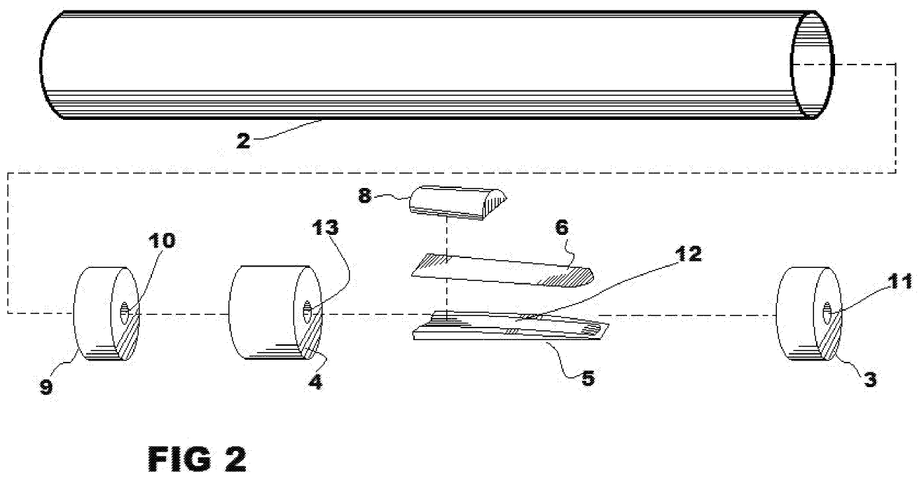

Referring to the drawings FIG. 2 is a perspective view of the present invention showing the parts and how they relate to each other. The main call body 2 may be a smooth cylindrical tube or with shape. The bushings 3 and 9 may be of any suitable material that would enclose the ends and could have an aperture drilled or formed into it that is the proper diameter to control the amount of air entering and exiting the call. Only the amount of air entering the call can get to the reed or voice of the call and also exit the call thus making the air controlled to make the sound of a whitetail female deer or doe. The bushing 4 may be made of a rubber material or other suitable material and inserted into the call body 2 or may be molded into the call body 2 with an aperture 13 properly sized for the secure holding of the voice or reed assembly.

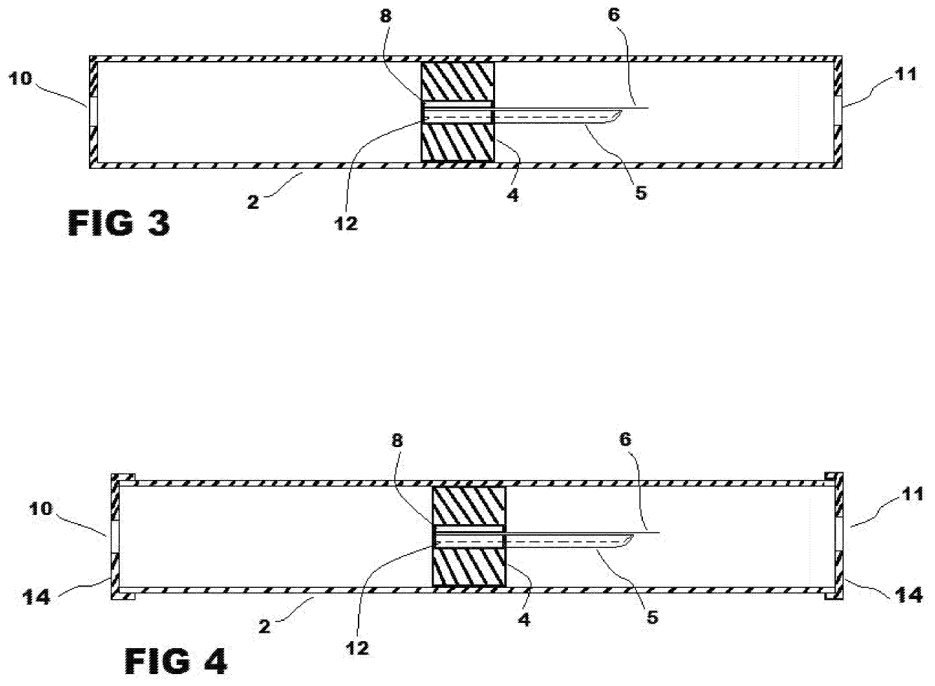

FIG. 3 shows an alternate version of the present invention with the main call body 2 being one solid piece with the bushing 4 being molded into the body and the mouth piece end and the exit end being an integral part of the main body with the small aperture 10 and the small aperture 11 being molded into the main body also without having to use bushings or plugs to seal the main call body 2.

FIG. 4 shows an alternate version of the present invention with the main body 2 being one solid piece with the bushing 4 being molded into the body and the mouth piece end and the exit end being enclosed with a cap 14 with a small aperture 10 and small aperture 11. This may also be done with a thin bushing with an outside diameter that is exactly the same as the inside diameter of call body 2 and may be glued into the mouth piece end and the exit end shown in FIG. 1 to control the amount of air that comes into and exits the call.

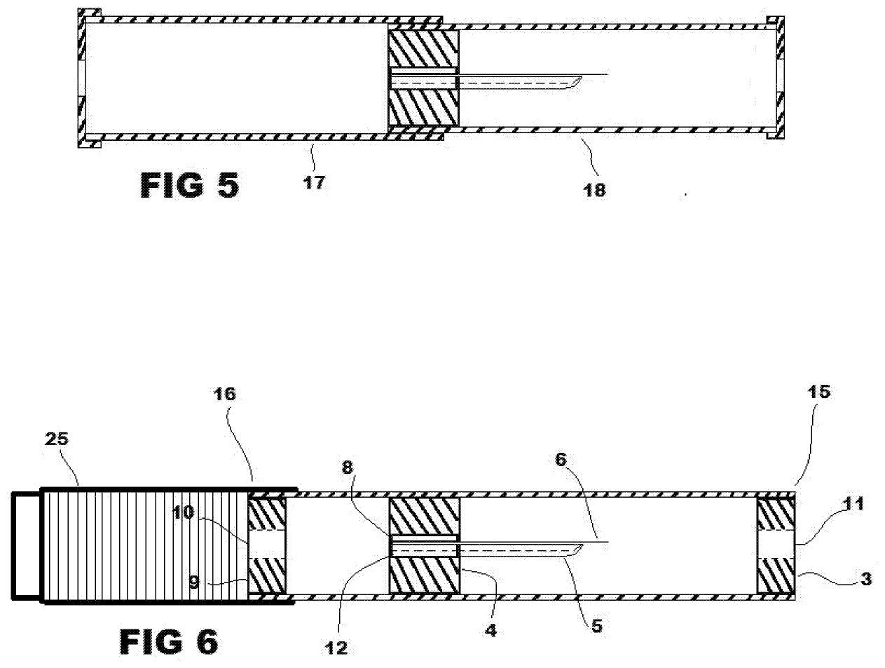

FIG. 5 Shows yet another version of the present invention that consist of the main call body being two separate pieces the mouth piece end 18 and the exit or barrel end 17 that may be put together to form the main body.

FIG. 6 Shows another alternate version of the present invention that consist of mouth piece end 15 with a bushing 3 and a small aperture 11 with a bushing 4 holding the voice inside the call and on the exit end with a bushing 9 with a small aperture 10 that is closer to the voice box and has a flexible plastic extendable tube 25 connected to the end that may give the call more inflection that may be desired by more advanced users.

While the embodiment of this device having a small diameter aperture on the mouth piece end of this device to control the amount of air going into the call that has been described and shown in detail herein, other modifications or changes could be made without departing from the scope of the invention.

I claim:

1. A game calling device comprising a main body portion that is generally cylindrical shape with a bore there through, that bore having a mouth piece end that has an aperture that is proportionally smaller in diameter than the bore through the main body to reduce the amount of air that will enter the calling device and thus reducing the amount of air that gets to the reed assembly thus allowing the restriction of air flow to keep said reed from locking or making unwanted sounds that is needed for said device to produce a quality sound with a minimal amount of air.

2. The game calling device in as defined in claim 1 which has a proportionally smaller aperture than the diameter of the bore of the main body on the exit end of the device to further control the amount of air escaping said device.

3. The game calling device as defined in claim 1 which has a reed assembly inserted and secured in the main bore of the device and is in communication with both the mouth piece end and the exit end of said bore allowing air to pass through said reed assembly to produce sound.

4. The game calling device defined in claim 3 that has a reed assembly consisting of a tone board and a reed and a wedge that secures down the reed to the exit end of said reed on top of said tone board that has a grove or channel in said tone board that allows air to pass under said reed on the entrance end of said reed in which causes the reed to vibrate and produce sound.

5. A game calling device comprising a main body portion that is generally cylindrical shape with a bore there through that is proportionately larger in diameter than the aperture size of the mouth piece end and an exit end that both have apertures that are equal in size to each other or allow equal amounts of air to enter and exit the calling device to further control the amount of air that passes under said reed assembly to create a consistent sound.
